(19) United States
(12) Patent Application Publication
(10) Pub. No.: US 2013/0174616 A1
(43) Pub. Date: Jul. 11, 2013

(54) DOUBLE LOOP ADJUSTABLE LEASH

(71) Applicant: JAMES C. ALLEN, JR., Scottsdale, AZ (US)

(72) Inventor: JAMES C. ALLEN, JR., Scottsdale, AZ (US)

(21) Appl. No.: 13/445,275

(22) Filed: Apr. 12, 2012

Related U.S. Application Data
(60) Provisional application No. 61/584,371, filed on Jan. 9, 2012.

(51) Int. Cl. A01K 27/00; E05B 73/00

(52) U.S. Cl. 70/30; 119/793

(57) ABSTRACT

A leash includes two selectively lockable loops at opposed ends. One loop is adjustable in size to fit about an animal's neck and includes a sheath for purposes of comfort and for defining the size of the first loop. A second loop is adjustable in size for the hand of a user or for attaching the leash to an anchor point. A sheath extends along the second loop for comfort and for defining the size of the second loop.

### CROSS REFERENCE TO RELATED APPLICATIONS

The present application includes subject matter disclosed in and claims priority to a provisional application entitled “Pet Locking Device With Handle” filed Jan. 9, 2012 and assigned Ser. No. 61/584,371 describing an invention made by the present inventor.

### BACKGROUND OF THE INVENTION

1. Field of the Invention

The present invention relates to leashes and, more particularly, to leashes having lockable and adjustable loops at opposed ends.

2. Description of Related Prior Art

Conventional leashes for pets include a loop at one end for grasping by a user. The other end of the leash generally includes a clasp of some type for detachable attachment to a ring extending from a collar about the neck of the pet. Sometimes a harness is mounted on the body of the pet and usually includes a ring extending therefrom for attachment to a leash. These leashes are generally of leather or webbing material. Some leashes may also be formed by a cord. For larger animals, the leash is generally formed from a chain; such chains may be of various types and sizes. Some leashes include a handle enclosing a spool for selectively extending and retracting a cord forming the leash.

While conventional leashes serve the primary purpose of restraining the freedom of a leashed animal, each requires the use of a collar, harness, or the like, mounted upon the animal and to which the leash is attached. Conventional leashes do not provide the ability to secure the leashed animal to an anchor, such as a post, railing, park bench, etc. without tying the free end of the leash about or threaded through such anchor. There is no locking mechanism to lockingly secure the leash to the animal nor to lockingly secure the leash to an anchor and prevent theft of the animal.

### SUMMARY OF THE INVENTION

The present invention is directed to a leash for an animal, which leash can and does serve several secondary functions apart from tethering an animal to a handheld leash. One end of the leash includes a lockable loop adjustable in size to correspond with the neck of the animal. The other end of the leash also includes a lockable loop adjustable for the hand of a user and lockingly engageable with an anchor to tether the animal in the absence of the user. A sheath extends about each loop for the comfort of the animal and the user. The leash itself is a cable that is not severable by chewing thereon by the animal nor by use of readily available conventional tools. The combination of locks and cable provide security measures to prevent inadvertent loss or theft of a leashed animal.

It is therefore a primary object of the present invention to provide a leash for an animal having lockable and adjustable loops at each end.

Another object of the present invention is to provide a sheath enclosing one or both loops of a leash for purposes of comfort.

Still another object of the present invention is to provide a leash which includes a lockable loop at one end serving as a collar for the leashed animal.

Yet another object of the present invention is to provide a leash that may be lockingly secured to an anchor to tether the leashed animal in the absence of a user.

A further object of the present invention is to provide a leash formed from a cable to prevent severance of the leash by the leashed animal chewing on the leash.

A still further object of the present invention is to provide a leash formed from a cable to prevent severance of the cable by use of conventional tools and prevent theft of the leashed animal.

A yet further object of the present invention is to provide a lockable loop for a leash to permit anchoring the leash to a fixed object.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates a cable forming a leash and having two lockable loops at respective ends;

FIG. 2 is a detailed view taken along lines 2-2, as shown in FIG. 1;

FIG. 3 illustrates a lock for locking attachment and detachment of the end of each loop;

FIG. 4 illustrates the rear of each lock mounted on the cable of the leash; and

FIG. 5 is a detail view of the support for the sheath formed at one or both loops.

### DESCRIPTION OF THE PREFERRED EMBODIMENT

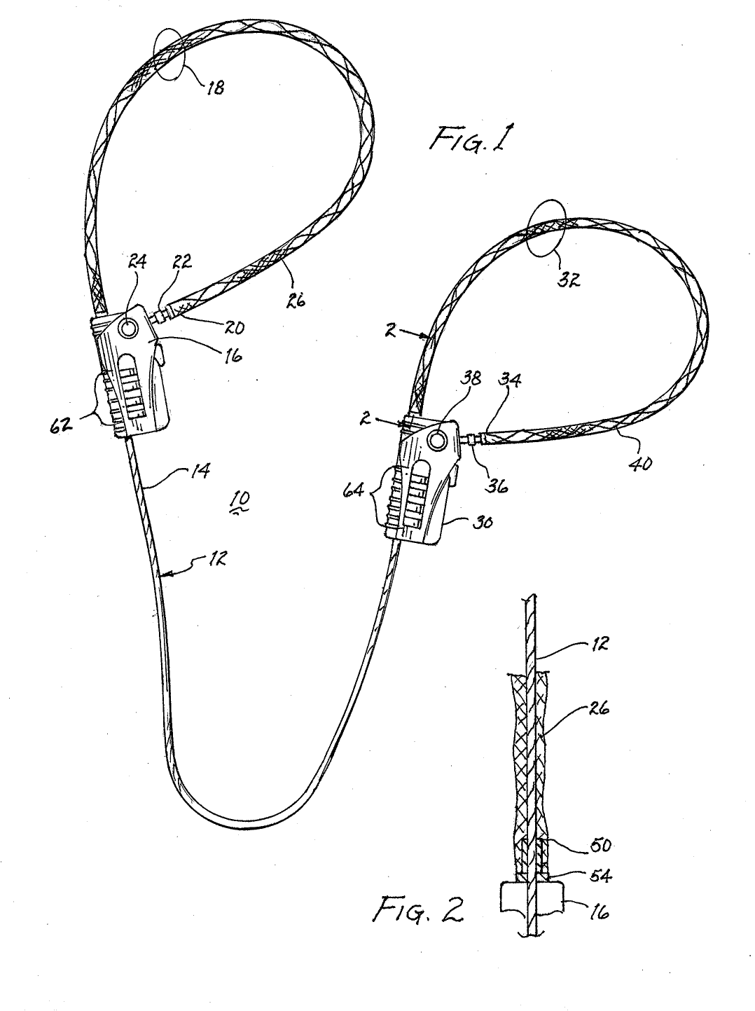

Referring to FIG. 1, there is illustrated a leash 10 formed from a cable 12. Preferably, the cable is encased within a plastic covering 14. A first lock 16, which may be a combination lock as shown, includes a passageway extending therethrough (not shown) for slidably receiving cable 12. A first loop 18 extends from lock 16 to terminal end 20. The terminal end includes a fitting 22 for lockingly engaging lock 16. A push button 24 on the lock releases fitting 22 when the button is depressed and after the correct combination is entered in the lock. A sheath 26 extends along the cable forming loop 18.

A second lock 30 is in slidable engagement with cable 12. It may be noted that lock 30 is identical with lock 16 and the above description also applies to lock 30. A second loop 32 extends from lock 30 to terminal end 34. A fitting 36 extends from the terminal end into locking engagement with lock 30. Push button 38 on the lock releases the fitting when the push button is depressed and after the correct combination is entered in the lock. A sheath 40 extends along the cable forming loop 32.

As particularly shown in FIGS. 1, 2 and 5, the size of each of loops 18, 32 may be readily adjusted to fit the neck of the animal to be leashed and the hand of the user using the leash, respectively. A ferrule 50 includes a central passageway 52 for snugly but slidably receiving cable 12. The ferrule includes an increased diameter collar 54. As particularly shown in FIGS. 2 and 5, cable 12 extends through ferrule 50 and sheath 26. The sheath is slid onto cylindrical body 56 of ferrule 50 to butt up against collar 54. A similar arrangement of cable, ferrule and sheath is present at terminal end 20 of loop 18. By cutting off a length of sheath 26, the distance between the ferrules at opposite ends of a sheath will be reduced resulting in a reduced size of loop 18. Thereby, the loop can be adjusted to fit the neck of any animal to be leashed. Loop 32 includes the same arrangement of cable, ferrule and sheath.

By modifying the length of sheath 40, the size of loop 32 may be adjusted to fit the requirements of the user holding the leash. It is to be noted that the passageway within each of the first and second locks for housing the cable permits some sliding movement of the cable but there is preferably a degree of friction present to prevent inadvertent and other than forced sliding movement of the cable relative to one or the other of the locks that might increase the size of the respective loop.

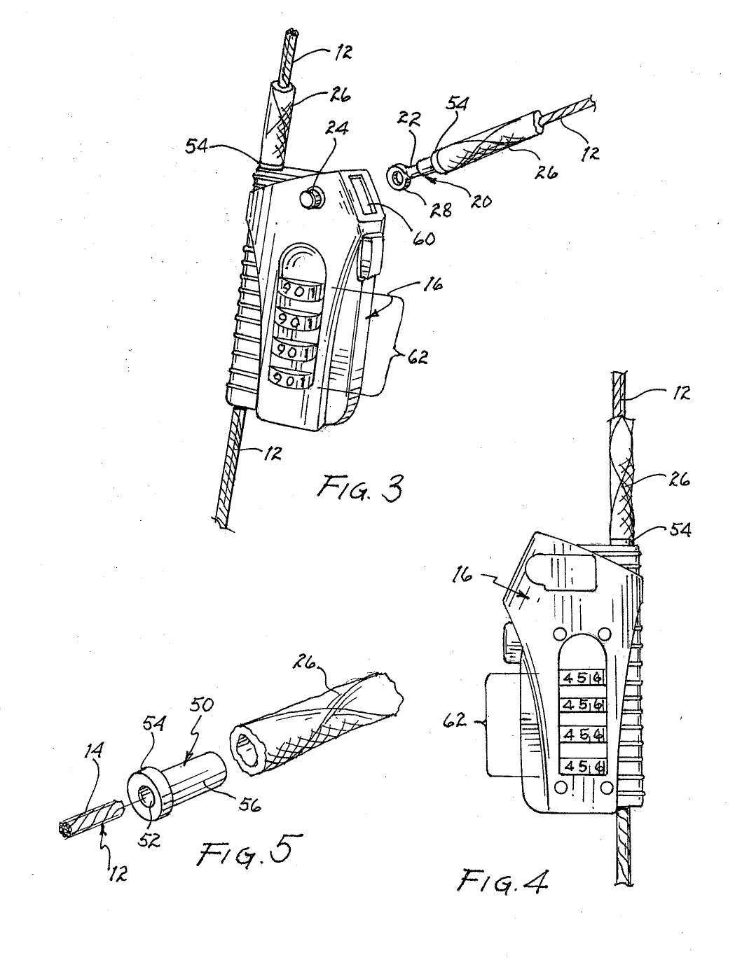

Referring particularly to FIGS. 3 and 4, the locking and unlocking of each of loops 18 and 32 will be described. While the reference numerals relate to lock 16, it is to be understood that lock 30 is identical with lock 16. Fitting 22 at terminal end 20 includes a ring 28. This ring mates with a prong internally disposed within lock 16 that engages the ring upon insertion of fitting 22 into the lock through opening 60. Upon depressing push button 24, the prong disengages from ring 28 and terminal end 20 may be withdrawn from within the lock. Thereby, the leashed animal may be disengaged from the leash. Similarly, depressing push button 38 of lock 30, terminal end 34 will be released from lock 30. It is to be noted that each of locks 16 and 30 is a combination lock. Only upon correct alignment of tumblers 62, 64, of combination locks 16, 30, respectively, can the push button be depressed to release the respective fitting.

Aside from leash 10 serving as a leash for an animal being walked, it has another important function. Loop 32, see FIG. 1, serves primarily as a hand hold for the leash. However, it is capable of serving an additional very important function. When a user walks an animal, such user may, from time to time, wish to enter a store, restaurant, office building, or other facility that does not permit entry of animals. Heretofore, the best such user can do is to tie the leash to some anchor outside of the establishment. While this may restrain the animal, it is very easy for a thief to untie the leash and walk off with or kidnap the animal. When the animal is of show quality, rare or otherwise very emotionally valuable, the loss may be significant coupled with the emotional loss that would be experienced.

Loop 32 can and does serve as a locking mechanism for securing the leash, and the animal, to a post, railing, park bench, or other fixed object. This is done by dialing in the correct combination and opening loop 32 upon depressing button 38 to release terminal end 34. The end of the loop may then be passed around the fixed object to which the leash is to be anchored. Thereafter, terminal end 34 is reinserted through opening 60 into locking engagement with lock 30 and rearranging the tumblers of the combination lock. It may be noted that both locks 16 and 30 are combination locks requiring that tumblers 62, 64, respectively, be set to a predetermined code in order to prevent withdrawal of respective terminal ends 20, 34 by depressing push buttons 24, 38, respectively. Thereby, not only is it impossible to remove loop 18 from about the neck of the animal and thereby disengage the animal from the leash, but it is also impossible to disengage the leash from an anchor to prevent theft of the animal. Upon return of the user, tumblers 64 of lock 30 are set to the appropriate code to permit button 38 to be depressed. Upon such depression, terminal end 34 may be withdrawn from lock 30 and the loop withdrawn from about the anchor. After such withdrawal, the terminal end may be reinserted within lock 30 to form loop 32.

It is to be understood that cable 12 may be sized to accommodate the weight and strength of the animal with which the leash is to be used. Moreover, sheath 26 extending about loop 18 may be of any thickness or cross-sectional physical size as a function of comfort for the animal. For example, an animal having a very heavy coat about its neck may be quite comfortable with a sheath of minimal size and thickness while an animal having essentially very short hair about its neck may be more comfortable with a padded and/or large diameter sheath to prevent chaffing or other discomfort. Similarly, sheath 40 extending about loop 32 may be sized and with a material selected to be most comfortable for a user using the loop as a handle of the leash. It may be noted that except for some longitudinal compression of the sheath for either loop 18 or loop 32, the length of the respective sheath essentially defines the size of the respective loop.

I claim:

1. A leash for an animal, said leash comprising:
(a) a cable;
(b) first and second locks mounted on said cable;
(c) a first end of said cable including a first fitting for engaging said first lock to form a first loop; and
(d) a second end of said cable including a second fitting for engaging said second lock to form a second loop.

2. The leash as set forth in claim 1 including a first sheath extending along said first loop.

3. The leash as set forth in claim 1 including a second sheath extending along said second loop.

4. The leash as set forth in claim 3 including a first sheath extending along said first loop.

5. The leash as set forth in claim 2 including a first pair of ferrules slidably mounted on the part of said cable forming said first loop for insertion between said cable and the opposed ends of said first sheath.

6. The leash as set forth in claim 3 including a second pair of ferrules slidably mounted on the part of said cable forming said second loop for insertion between said cable and the opposed ends of said second sheath.

7. The leash as set forth in claim 6 including a first pair of ferrules slidably mounted on the part of said cable forming said first loop for insertion between said cable and the opposed ends of said first sheath.

8. The leash as set forth in claim 1 wherein each of said first and second locks are combination locks.

9. The leash as set forth in claim 8 wherein said first lock includes a first button for releasing said first fitting.

10. The leash as set forth in claim 8 wherein said second lock includes a second button for releasing said second fitting.

11. The leash as set forth in claim 10 wherein said first lock includes a first button for releasing said first fitting.

12. The leash as set forth in claim 9 wherein said first lock includes a first cavity for receiving said first fitting into locking engagement with said first lock.

13. The leash as set forth in claim 10 wherein said second lock includes a second cavity for receiving said second fitting into locking engagement with said second lock.

14. The leash as set forth in claim 11 wherein said first lock includes a first cavity for receiving said first fitting into locking engagement with said first lock and wherein said second lock includes a second cavity for receiving said second fitting into locking engagement with said second lock.

15. The leash as set forth in claim 1 wherein said cable includes a plastic covering.

16. The leash as set forth in claim 15 wherein each of said first and second locks are combination locks.
